(19) United States
(12) Patent Application Publication
(10) Pub. No.: US 2003/0189967 A1
(43) Pub. Date: Oct. 9, 2003

(54) Method for monitoring a gas appliance, in particular a heat generator, with predominantly flameless oxidation, and monitoring module for performing the method

(76) Inventors: Volker Rumelin, Herrenberg (DE); Andreas Laug, Bronnweiler (DE)

Correspondence Address: JONES, TULLAR & COOPER, P.C., P.O. Box 2266 Eads Station, Arlington, VA, 22202, US

(21) Appl. No.: 10/139,633

(22) Filed: May 7, 2002

(30) Foreign Application Priority Data
Apr. 4, 2002 (DE) 102 14 879.1

(51) Int. Cl. G01K 17/00

(52) U.S. Cl. 374/31

(57) ABSTRACT

A monitoring module for monitoring the safe operation of heat generators is proposed, which is also usable if a predominantly flameless or even completely flameless oxidation occurs in the heat generator.

### SPECIFICATION

The invention relates to a method for monitoring a gas appliance, in particular a heat generator, with predominantly flameless oxidation, and monitoring module, for monitoring a heat generator with predominantly flameless oxidation.

In conventional automatic flame monitors, which are used to monitor the flame in a heat generator, the ionization caused by the flame is utilized to detect the presence of a flame. If a flame is no longer present, the supply of fuel to the heat generator is interrupted, thus precluding a risk from uncombusted fuel. These automatic flame monitors cannot be used whenever the oxidation of the fuel, which is preferably gas, is effected predominantly flamelessly or even completely flamelessly, as in the so-called FLOX process, for instance. Methods for predominantly flameless or completely flameless oxidation offer many advantages, for instance in terms of emissions, over conventional combustion of fuel in a flame.

The object of the invention is to furnish a method for monitoring a heat generator with predominantly flameless or completely flameless oxidation, as well as a monitoring module, for instance an automatic flame monitor, for monitoring a heat generator with predominantly flameless or completely flameless oxidation.

According to the invention, this object is attained with a method defined by the following method steps:

detecting a first characteristic temperature of the heat generator;

comparing the first characteristic temperature with a predetermined first limit value;

closing a first relay if the first characteristic temperature is above the predetermined first limit value;

detecting a second characteristic temperature of the heat generator;

comparing the second characteristic temperature with a predetermined second limit value;

closing a second relay if the second characteristic temperature is above the predetermined second limit value; and

opening a main gas ramp and/or a starting gas ramp for supplying gas to the heat generator if both the first relay and the second relay are closed.

By this method, which is designed to be redundant, the delivery of fuel to the heat generator is opened only, or remains open only, if it is ascertained redundantly that a temperature as high as occurs in oxidation of the fuel in the heat generator is prevailing in the heat generator. This assures that the fuel will be oxidized completely, and as a consequence there is no further risk from the fuel.

If the second relay is opened, or the second microcontroller is malfunctioning, the first microcontroller interrupts the signal communication between the first temperature sensor and the first amplifier and comparator, and as a consequence the first relay opens, thus assuring that the delivery of fuel to the heat generator is interrupted.

In a further feature of the method of the invention, the second microcontroller interrupts the signal communication between the second temperature sensor and the second amplifier and comparator if the first relay is opened, or if the first microcontroller is malfunctioning.

For monitoring the monitoring module of the invention, it is furthermore provided that at periodic intervals, the first microcontroller interrupts the signal communication between the first temperature sensor and the first amplifier and comparator, and that the signal communication is restored again only if as a consequence of the signal interruption, the second microcontroller also interrupts the signal communication between the second temperature sensor and the second amplifier and comparator. By this further-refined method of the invention, all the components of the monitoring module are monitored in terms of their function at periodic intervals. As soon as a component malfunctions, the delivery of fuel to the heat generator is interrupted, so that even if the monitoring module malfunctions, there is no risk to the environment from uncombusted fuel.

In a further inventive feature of the method, it is provided that at periodic intervals, the second microcontroller interrupts the signal communication between the second temperature sensor and the second amplifier and comparator, and that the signal communications between the first temperature sensor and the first amplifier and comparator and between the second temperature sensor and the second amplifier and comparator are restored only if as a consequence of the signal interruption, the first microcontroller also interrupts the signal communication between the first temperature sensor and the first amplifier and comparator.

It is thus assured continuously during operation of the heat generator that the heat generator will function properly.

Alternatively, the function of the monitoring module can also be monitored by providing that at periodic intervals, the first microcontroller interrupts the signal communication between the first temperature sensor and the first amplifier and comparator, and that the signal communication between the first temperature sensor and the first amplifier and comparator is restored again only if as a consequence of the signal interruption the second microcontroller sends a positive report back to the first microcontroller. This method can also be performed analogously by the second microcontroller. In this somewhat simplified test method, only part of the monitoring module is monitored at any particular time. Not until each of the two both microcontrollers have performed the self-test once is the entire monitoring module tested. However, this is no disadvantage, if the frequency of the self-tests is increased accordingly.

The aforementioned object is also attained by a monitoring module for monitoring a heat generator with predominantly or completely flameless oxidation, having a first temperature limit value switch, which includes a first temperature sensor, a first amplifier and comparator, and a first relay; having a second temperature limit value switch, which includes a second temperature sensor, a second amplifier and comparator, and a second relay; having a first microcontroller and a second microcontroller, of which the second microcontroller, via a signal line, receives a signal pertaining to the switching state of the first relay, and the first microcontroller, via a signal line, receives a signal pertaining to the switching state of the second relay, and the first microcontroller, via a signal line, can interrupt the signal communication between the first temperature sensor and the first amplifier and comparator, and the second microcontroller, via a signal line, can interrupt the signal communication between the second temperature sensor and the second amplifier and comparator; and having a signal line for internal communication between the first microcontroller and the second microcontroller.

With the monitoring module of the invention, even with predominantly flameless or even completely flameless oxidation of the fuel in a heat generator, it is possible to assure that the fuel will oxidize, thus precluding any risk from uncombusted fuel. Since the monitoring module of the invention has recourse not to ionization but rather to measured temperatures, it is assured that regardless of whether flame formation is present or not, the oxidation of the fuel, which leads to a temperature increase, will be detected reliably, and in the absence of fuel oxidation, the delivery of fuel can be shut off.

Further advantages and advantageous features of the invention will be described below in conjunction with the drawing.

Shown are:

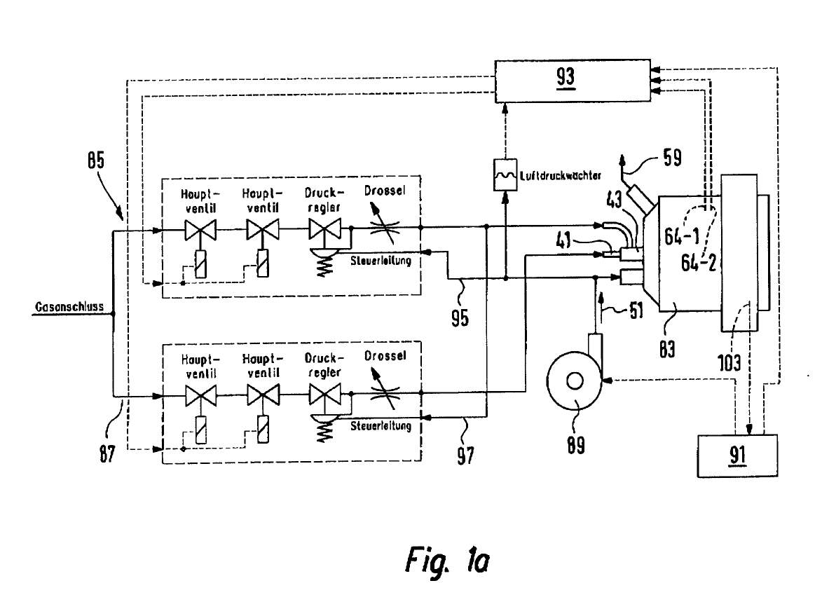

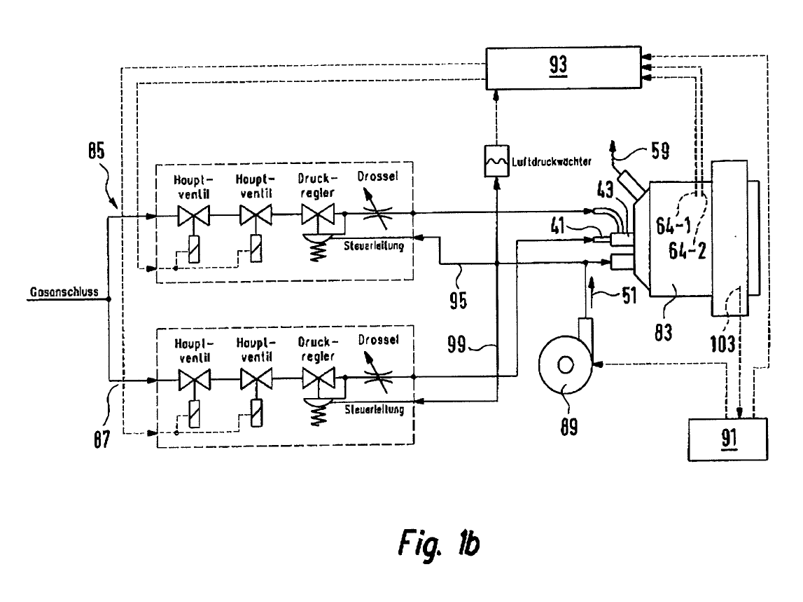

FIGS. 1a-c, a block circuit diagram of a heat generator of the invention, including a supply of gas and combustion air; and

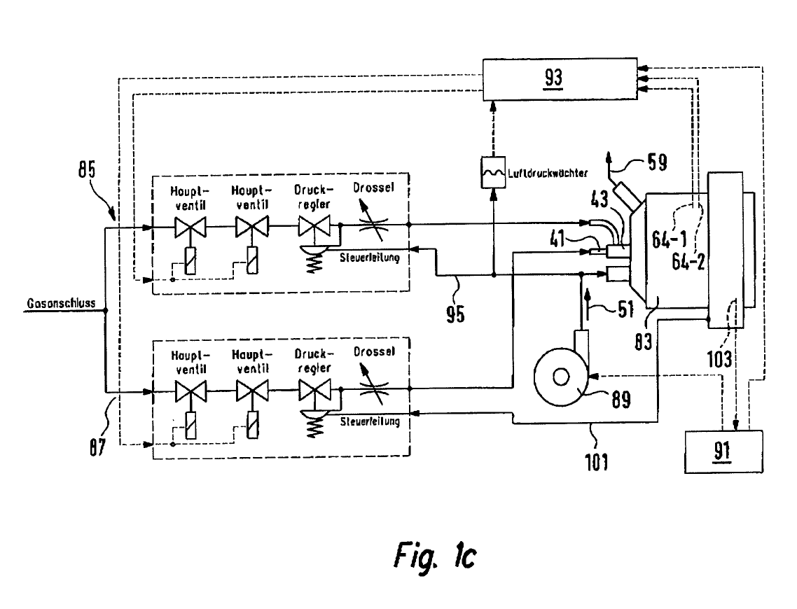

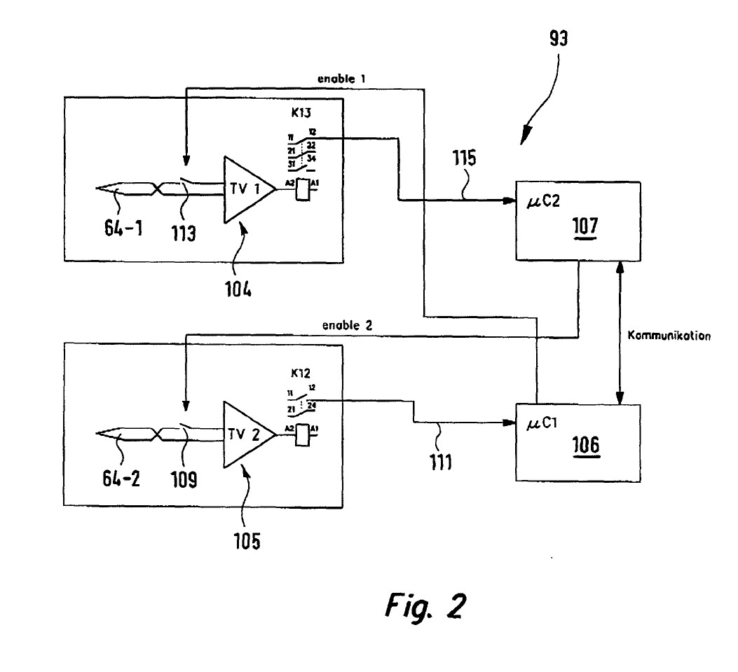

FIG. 2, a schematic layout of a monitoring module for monitoring a gas appliance.

In FIGS. 1a, 1b and 1c, a block circuit diagram of a heat generator is shown in each case, identified here in its entirety by reference numeral 33, for a Stirling engine (not shown), and its gas supply, comprising a starting gas segment 85 and a main gas segment 87. The heat generator 83 is one example of a gas appliance. The choice of this example does not limit the invention to this particular use. As the gas appliance, among others, micro-gas turbines or the heat generators of force-heat coupling systems, such as fuel cells, or steam engines can be considered. The method and the control unit 93 of the invention can be used especially preferably if the heat generation in the gas appliance is effected predominantly flamelessly or even completely without flame formation, as is the case in the flameless oxidation method (FLOX method). In these cases, conventional automatic flame monitors, because they use the ionization caused by the flame to monitor the flame, that is, the function of the heat generator, are inadequate.

In a predominantly or completely flameless oxidation method, the heat generator 83 must first be brought to operating temperature, by means of the starting gas ramp and a conventional burner. After that, the starting gas ramp 85 can be closed, and the main gas ramp 87, which is used to supply gas for the flameless oxidation process, can be opened.

The starting gas segment 85 and main gas segment 87 are controlled by a monitoring module 93. The method monitored by the monitoring module 93, and the monitoring module 93 itself, are essential components of the invention.

Essentially, FIGS. 1a-c differ solely in terms of the supplies of control pressure to the pressure regulator of the main gas ramp 87 and the type of pressure regulator. With each of the control pressure supplies shown in FIGS. 1a, 1b and 1c, a modulated operation of the heat generator 83 of the invention is possible. Slight differences exist in terms of the capability of modulation and other operating parameters, as well as costs.

The starting gas segment 85 is required to bring the heat generator to the requisite operating temperature. The starting gas ramp 85 supplies a conventional burner (not shown) with fuel. In this burner, combustion with flame formation occurs, which is monitored by a conventional automatic flame monitor.

The combustion air, which is indicated in FIG. 1 by the arrow 51, is delivered to the heat generator 83 by a blower 89. A control unit 91 serves both to control the heat generator 83 and to trigger a monitoring module 93. The starting gas segment 85 and the main gas segment 87 are triggered by the monitoring module 93. The flue gas leaves the heat generator 83 at the point marked by the arrow 59.

If the heat generator 83 is to be put into operation, the control unit 91 outputs a signal accordingly to a blower 89 for the combustion air and on to the monitoring module 93, which thereupon turns on the starting gas segment 85. Signal communications are represented by dashed lines in FIGS. 1a-c.

The starting gas segment 85 comprises two series-connected main valves, with which the delivery of gas to a second fuel lance 43 can be turned on or off. A pressure regulator is provided adjoining it. The pressure regulator can be embodied as an equal-pressure regulator or as a proportional-pressure regulator. Depending on the embodiment of the pressure regulator, an adjustable throttle can be present in the starting gas segment.

The pressure regulator for the starting gas ramp 85, in the exemplary embodiments of FIGS. 1a-c, communicates with the outlet of the blower 89 via a first control line 95. This means that as the control pressure for the pressure regulator of the starting gas segment 85, the pressure of the combustion air downstream of the blower 89 is used. Via a conventional automatic flame monitor (not shown) integrated with the monitoring module 93, the second fuel lance 41, and the combustion is monitored. The starting gas ramp 85 can be embodied as a so-called compact fitting.

Once the heat generator 83 has reached its operating temperature, which is indicated by two temperature sensors, designated in FIG. 1 as 64-1 and 64-2, the monitoring module 93, which receives the signals of the temperature sensors 64-1 and 64-1, enables the main gas ramp 87 and switches the starting gas ramp 85 off. The main gas ramp 87 is constructed similarly to the starting gas ramp 85; that is, it comprises two main valves, a pressure regulator, and optionally a throttle. The pressure regulator can, as in the starting gas ramp 85, be embodied as an equal-pressure regulator or as a proportional-pressure regulator.

In FIG. 1a, as the control pressure of the pressure regulator valve of the main gas ramp 87, the pressure in the starting gas ramp 85 downstream of the main valves can be used. If the main gas ramp 87 is in operation, the valves of the starting gas ramp 85 are closed, so that downstream of the main valves in the starting gas ramp 85, the same pressure prevails as in the second fuel lance 43 and in the pre-combustion chamber 29. Since the temperatures of the starting gas ramp 85, at the place where the control pressure for the pressure regulator of the main gas ramp is picked up via a second control line 97, are markedly lower than in the pre-combustion chamber 29, it is simpler and more operationally reliable to detect the pressure of the starting gas ramp 85 than to pick up the pressure directly in the pre-combustion chamber 29. In FIG. 1b, an alternative is shown, in which the control pressure of the main gas ramp 87 is detected downstream of the blower 89, via a third control line 99 and the first control line 95. In this variant as well, the additionally required third control line 99 is not exposed to any high temperatures. Nevertheless, a modulating mode of operation is readily possible, although the range of modulation may be somewhat restricted compared to the exemplary embodiment of FIG. 1a.

In FIG. 1c, a third alternative is shown, in which a fourth control line 101 detects the pressure in the combustion chamber 30 (for which, see FIG. 2) of the heat generator 83. This pressure serves as the control pressure for the main gas ramp 87. In this embodiment as well, a modulating mode of combustion is readily possible. In this exemplary embodiment, the pressure regulator is embodied as a proportional-pressure regulator. A throttle in the main gas ramp 87 can therefore be dispensed with.

To adapt the output of the heat generator 83 to the demanded heat output, a third temperature sensor 103 is disposed in a heat exchanger of the heat generator 83. The output signal of the third temperature sensor 103 is carried on to the control unit 91. If the temperature detected by the third temperature sensor 103 increases, this means that less heat is extracted, and thus the control unit 91 can lower the rpm of the blower 89, and the quantity of combustion air is reduced. Alternatively, a throttle valve can be closed somewhat more extensively, to reduce the quantity of air fed into the heat generator 83 by the blower 89. The throttle valve is not shown in FIGS. 1a, 1b and 1c.

Because of the reduced quantity of combustion air, the pressure in the second fuel lance 23 or pre-combustion chamber 29 (see FIG. la) also varies. The pressure downstream of the blower 89 furthermore varies, as does the pressure in the combustion chamber of the heat generator 83.

Because of these pressure changes, which as already described above can be used as control pressure changes for the pressure regulator of the main gas segment 87, the supply of gas via the main gas segment 87 is adapted to the altered quantity of combustion air.

Depending on the design of the pressure regulator, it may be helpful to provide a throttle downstream of the pressure regulator, in order to assure an optimal adaptation of the gas quantity to the quantity of combustion air at all operating points.

As soon as the monitoring module 93 detects a malfunction of the heat generator 83, the main gas segment 87 and the starting gas segment 85 are closed, so that no uncombusted fuel can reach the environment, and thus there is also no risk. The structure and mode of operation of the monitoring module 93 will now be described in conjunction with FIG. 2.

The monitoring module 93 comprises a first and second temperature limit value switch 104 and 105 as well as a first and second microcontroller 106 and 107, which monitor both the function of the temperature limit value switches 104, 105 and each other.

The first temperature limit value switch 104 comprises a first amplifier and comparator TV 1, a temperature sensor 64-1, and a relay K13. The second temperature limit value switch comprises a second amplifier and comparator TV 2, a temperature sensor 64-2, and a relay K12.

The first amplifier and comparator TV 1 monitors whether the signal of the first temperature sensor 64-1 is greater than or equal to a predetermined limit value. In the same way, the second amplifier and comparator TV 2 monitors whether the temperature ascertained by the second temperature sensor 64-2 is greater than or equal to a limit value. If the temperatures ascertained by the temperature sensors 64-1 and 64-2 are greater than the aforementioned limit values, then the relay K12 is enabled by the first amplifier and comparator TV 1, and the relay K13 is enabled by the second amplifier and comparator TV 2, so that the main valves of the starting gas ramp 85 or of the main gas ramp 87 can be opened (see FIG. 1). The main valves of the starting gas ramp 85 and the main gas ramp 87 are opened only if both the relay K12 and the relay K13 are enabled.

In a signal line extending between the first temperature sensor 64-1 and the first amplifier and comparator TV 1, a first switch 113 is provided, which can be triggered by the first microcontroller 106 via a line enable 1. In a signal line extending between the second temperature sensor 64-2 and the first amplifier and comparator TV 2, a second switch 109 is provided, which can be triggered by the second microcontroller 107 via a line enable 2.

At periodic time intervals, either the switch 109 or the switch 113 is opened by a microcontroller 106 or 107, in order to check whether the first temperature limit value switch 104 and the second temperature limit value switch 105 are functional.

If for instance the first microcontroller 106 opens the first switch 113, and as a consequence the first amplifier and comparator TV 1 no longer receives any temperature signal from the first temperature sensor 64-1, then the first amplifier and comparator TV 1 opens the relay K13. Via a signal line 115, the second microcontroller 107 receives a corresponding signal, whereupon this microcontroller 107 opens the second switch 109. As a consequence, the relay K13 is opened analogously, and thus the delivery of gas in the starting gas segment 85 or the main gas segment 87 (not shown here) is turned off. This periodic self-test of the monitoring module 93 can also be initiated by the second microcontroller 107.

This self-test of the monitoring module 93 lasts less than one second, so that—on the condition that the test was successful—after the opening of the gas delivery to the main gas ramp 87, which ensues immediately after the test, the flameless oxidation immediately resumes, and the heat generator 83 has no disadvantages from the brief interruption in the gas delivery. In this way, the function of the monitoring module 93 can be monitored continuously.

By means of an internal communication between the second microcontroller 107 and the first microcontroller 105, the functioning of both microcontrollers 105 and 107 is moreover monitored continuously. As soon as a fault in one of the microcontrollers 105 or 107 is found, or if the test of the limit value switches 104 or 105 indicates a malfunction, the gas delivery to the heat generator 83 is interrupted. This is done by providing for instance that the second microcontroller 107, via the signal line enable 2, opens the switch 109, thus interrupting the signal communication between the second temperature sensor 64-2 and the second amplifier and comparator TV 2. As a consequence, the relay K12 is opened, and the gas delivery to the starting gas ramp 85 and the main gas ramp 87 is closed.

In the reverse case, the first microcontroller 106 triggers the switch 113 if a malfunction has been detected by the monitoring module 93. In that case, the signal communication between the temperature sensor 64-1 and the relay K13 is interrupted, so that as a consequence, the gas delivery to the starting gas ramp 85 and the main gas ramp 87 is interrupted.

Alternatively, the self-test of the monitoring module 93 can also be performed as follows:

The first microcontroller 106 interrupts the signal communication between the first temperature sensor 64-1 and the first amplifier and comparator TV 1. The second microcontroller 107 detects this interruption via the signal line 115 and reports the interruption to the first microcontroller 106, via the internal communication. The first microcontroller 106 thereupon closes the first switch 113 again, so that the signal of the first temperature sensor 64-1 reaches the first amplifier and comparator TV 1 again.

At a later time, in the same way, the second temperature sensor 64-2, the second switch 109, the second amplifier and comparator TV 2, and the relay K12 can be checked.

All the characteristics shown in the drawing and recited in the description and the claims can be essential to the invention, both individually and in arbitrary combination with one another.

1. A method for monitoring the function of a gas appliance, in particular a heat generator, with predominantly flameless oxidation, having a monitoring module (93) of claim 1, characterized by the following method steps:
detecting a first characteristic temperature (64-1) of the heat generator (83);
comparing the first characteristic temperature (64-1) with a predetermined first limit value;
closing a first relay (K13) if the first characteristic temperature (64-1) is above the predetermined first limit value;
detecting a second characteristic temperature (64-2) of the heat generator (83);
comparing the second characteristic temperature (64-2) with a predetermined second limit value;
closing a second relay (K12) if the second characteristic temperature (64-2) is above the predetermined second limit value; and
opening a main gas ramp (87) and/or a starting gas ramp (85) for supplying gas to the heat generator (83) if both the first relay (K13) and the second relay (K12) are closed.

2. The method of claim 1, characterized in that the first microcontroller (106) interrupts the signal communication between the first temperature sensor (64-1) and the first amplifier and comparator (TV 1), if the second relay (K12) is opened or if the second microcontroller (107) is malfunctioning.

3. The method of claim 1 or 2, characterized in that the second microcontroller (107) interrupts the signal communication between the second temperature sensor (64-2) and the second amplifier and comparator (TV 2), if the first relay (K13) is opened or if the first microcontroller (106) is malfunctioning.

4. The method of one of the foregoing claims, characterized in that at periodic intervals, the first microcontroller (106) interrupts the signal communication between the first temperature sensor (64-1) and the first amplifier and comparator (TV 1), and that the signal communications between the first temperature sensor (64-1) and the first amplifier and comparator (TV 1) and between the second temperature sensor (64-2) and the second amplifier and comparator (TV 2) are restored only if as a consequence of the signal interruption, the second microcontroller (107) also interrupts the signal communication between the second temperature sensor (64-2) and the second amplifier and comparator (TV 2).

5. The method of one of the foregoing claims, characterized in that at periodic intervals, the second microcontroller (107) interrupts the signal communication between the second temperature sensor (64-2) and the second amplifier and comparator (TV 2), and that the signal communications between the first temperature sensor (64-1) and the first amplifier and comparator (TV 1) and between the second temperature sensor (64-2) and the second amplifier and comparator (TV 2) are restored only if as a consequence of the signal interruption, the first microcontroller (106) also interrupts the signal communication between the first temperature sensor (64-1) and the first amplifier and comparator (TV 1).

6. The method of one of claims 1-3, characterized in that at periodic intervals, the first microcontroller (106) interrupts the signal communication between the first temperature sensor (64-1) and the first amplifier and comparator (TV 1), and that the signal communication between the first temperature sensor (64-1) and the first amplifier and comparator (TV 1) is restored again only if as a consequence of the signal interruption the second microcontroller (107) sends a positive report back to the first microcontroller (106).

7. The method of one of claims 1-3 and 5, characterized in that at periodic intervals, the second microcontroller (107) interrupts the signal communication between the second temperature sensor (64-2) and the second amplifier and comparator (TV 2), and that the signal communication between the second temperature sensor (64-2) and the second amplifier and comparator (TV 2) is restored again only if as a consequence of the signal interruption the first microcontroller (106) sends a positive report back to the first amplifier and comparator (TV 1).

8. A monitoring module for monitoring a heat generator (83) with predominantly flameless or entirely flameless oxidation, characterized in that it is suitable for performing a method of one of the foregoing claims.

9. The monitoring module of claim 8, characterized in that it has a first temperature limit value switch (104), and the first temperature limit value switch (104) includes a first temperature sensor (64-1), a first amplifier and comparator (TV 1), and a first relay (K13); that it has a second temperature limit value switch (105), and the second temperature limit value switch (105) includes a second temperature sensor (64-2), a second amplifier and comparator (TV 2), and a second relay (K12); that it has a first microcontroller (106) and a second microcontroller (107), and the second microcontroller (107), via a signal line (115), receives a signal pertaining to the switching state of the first relay (K13), and the first microcontroller (106), via a signal line (111), receives a signal pertaining to the switching state of the second relay (K12), and the first microcontroller (106), via a signal line (enable 1), can interrupt the signal communication between the first temperature sensor (64-1) and the first amplifier and comparator (TV 1), and the second microcontroller (107), via a signal line (enable 2), can interrupt the signal communication between the second temperature sensor (64-2) and the second amplifier and comparator (TV 2); and that a signal line (117) for internal communication is provided between the first microcontroller (106) and the second microcontroller (107).

10. The monitoring module of claim 8 or 9, characterized in that it is usable for monitoring a heat generator of a Stirling engine, a fuel cell, a steam engine, and/or a micro-gas turbine.
